(19) United States
(12) Patent Application Publication
(10) Pub. No.: US 2012/0301771 A1
(43) Pub. Date: Nov. 29, 2012

(54) ENERGY STORE DEVICE

(75) Inventors: Michael Moser, Rainau (DE); Tobias Isermeyer, Stuttgart (DE); Christoph Fehrenbacher, Stuttgart (DE); Thomas Heckenberger, Leinfelden-Echterdingen (DE); Hans-Georg Herrmann, Stuttgart (DE); Dirk Neumeister, Stuttgart (DE); Rudolf Riedel, Pforzheim (DE); Christian Zahn, Dresden (DE)

(73) Assignee: BEHR GmbH & Co. KG

(21) Appl. No.: 13/505,920

(22) PCT Filed: Nov. 8, 2010
(86) PCT No.: PCT/EP2010/066990

§ 371 Date: Aug. 15, 2012

(30) Foreign Application Priority Data
Nov. 6, 2009 (DE) 10 2009 052 254.9

(51) Int. Cl. H01M 10/50; F28D 15/00

(52) U.S. Cl. 429/120; 165/104.33

(57) ABSTRACT

The present invention relates to an energy store device, comprising a plurality of cooling channels, which are disposed in a plane spaced apart from each other substantially parallel to each other and designed for a cooling fluid to flow through them, at least one collection box, which is disposed in the plane with and substantially perpendicular to the plurality of cooling channels and is connected thereto to take up the cooling fluid therefrom or release it therein, and with a stack composed of a plurality of electrochemical energy store units, which are disposed such that between two adjacent cooling channels of the plurality of cooling channels at least one energy store unit from the plurality of electrochemical energy store units is disposed, respectively.

The present invention relates to an energy store device and to the use of a cooling device for cooling a stack of a multiplicity of electrochemical energy store units.

For a connection of cells, in particular Li-ion cells, to a heat sink, it is possible to provide a connection of cooling sheets of various designs to a cooling plate.

Document 102007066944.4 describes inter alia a cooling means for battery flat cells, which exhibits cooling sheets as a thermal path. It is mentioned that the sheets are in thermal contact with the cooling plate; it is sought to produce said contact by sealing.

The patent DE 102 23 782 B4 describes a cooling device for round cells, composed of a base plate and cooling elements which abut against the cells laterally in the longitudinal direction. The cells are connected in a force-fitting manner to the cooling device, and the abutting cooling elements have expansion joints in order to improve the problem of gap formation and of heat transfer.

The lecture “The Impact of Simulation Analysis on the Development of Battery Cooling Systems for Hybrid Vehicles” (by Peter Pichler, Product Manager Battery Systems, MAGNA STEYR Fahrzeugtechnik AG & Co. KG) at the Advanced Automotive Battery Conference (AABC) 2008 describes a modular battery construction in which the heat sink is however already integrated into the modules. Only the connection of the individual cooling ducts is produced during the completion of the battery.

The patent US 2008/0090137 describes a modular construction of a battery in which the module is composed of cells and cooling sheets. The finished battery is air-cooled.

The cooling ducts or the evaporator plate permit, in most cases, a connection of the cells only on one side, which impairs the heat distribution in the cell. Owing to installation space, the contact area for heat transfer to the heat sink is limited, as a result of which the dissipation of heat is hindered, in particular when large amounts of heat are generated. The force-fitting connections to the heat sink such as are used here are cumbersome and in part complex, and at the same time are inferior to cohesive connections. The accessibility for assembly often prevents additional mechanical support, in particular of “coffee bag” cells, for example by means of a frame or form-fitting encapsulation. For positively locking connections, use is made primarily of methods such as soldering or welding, but these damage the cells.

Furthermore, the heat sink or evaporator plate must be redesigned for every design concept of a module or of an entire battery, thus increasing the development expenditure and the number of variants.

Furthermore, the interconnection of individual cooling modules with dedicated heat sinks is cumbersome and increases the risk of leaks. An overall cooling plate for multiple modules can easily reach installation space dimensions which complicate the manufacture thereof. The partially solid construction of the heat sink and the additional connecting elements furthermore has an adverse effect on the overall weight of the battery.

It is the object of the present invention to create an improved device for cooling electrochemical energy store units, and a novel use of a cooling device.

Said object is achieved by means of an energy store device as per claim 1 and the use of a cooling device as per claim 13.

The present invention is based on the realization that the use of modified mass-produced parts and methods based on flat tube coolant coolers or evaporators can permit a reduction in development outlay and production costs. The essence of the invention, aside from improved modularity, is also an increase in heat dissipation, an improvement in the heat distribution in the cell as a result of a connection of heat sinks to multiple sides of the cells, and improved ease of assembly of the connection of the cooling sheet and heat sink. Furthermore, the packaging density can be optimized by means of adapted cooling sheets and a connection of the flat tubes in unused intermediate spaces of the cells. Furthermore, it is possible to attain a reduction in weight and an increase in mechanical stability with a simultaneous simplification of assembly.

It is advantageously possible for development outlay and production costs to be reduced through the use of modified mass-produced parts. The use of a flat-tube cooler or evaporator permits a highly variable, modular construction. A high packaging density can be attained through the optimum utilization of empty spaces. Since a variable arrangement of heat sinks can be attained in accordance with the cooling demand and the conductor position, it is furthermore possible to obtain increased heat dissipation and improved heat distribution in the cell. Aside from the reduction in weight, support of the mechanical stability is obtained with a simultaneous simplification of assembly and improvement in connection quality.

According to a further embodiment, the approach according to the invention can be used in particular for prismatic hard-case cells and “coffee bag” cells. An increase in heat dissipation is attained through the direct connection of the cells to the heat sink. Furthermore, an adaptation of cooling capacity can be attained by means of a variable number of flat tubes. The approach according to the invention advantageously permits tolerance compensation and flexibility in the cell assembly. Furthermore, owing to the low transfer resistances, cooling of battery cells with comparatively high inlet temperatures is made possible.

The approach according to the invention thus yields the further advantages of cohesive, reliable joining of the flat tubes to a collecting tank, improved heat dissipation in the cell as a result of direct connection to the heat sink, and a cooling capacity which meets demand through the variable number of flat tubes.

In a further embodiment of the invention, the approach described here can be used in particular for “coffee bag” cells. Through the direct connection of the cell or the cell conductor to the heat sink, an increase or improvement in the heat dissipation in the cell can be realized.

A further embodiment of the invention yields the advantages of improved assembly, a larger contact surface and latching of the energy store module into a structural component or the like.

The present invention provides an energy store device having the following features: a multiplicity of cooling ducts which are arranged spaced apart from one another and substantially parallel in a plane and which are formed such that a cooling fluid can flow through them; at least one collecting tank which is arranged in the plane with and substantially perpendicular to the multiplicity of cooling ducts and is connected to said cooling ducts in order to receive the cooling fluid therefrom or deliver the cooling fluid thereto; and a stack of a multiplicity of electrochemical energy store units which are arranged such that in each case at least one energy store unit of the multiplicity of electrochemical energy store units is arranged between two adjacent cooling ducts of the multiplicity of cooling ducts.

The energy store device is composed of an electrochemical energy store unit and at least one cooling device. Said energy store device may be used in a vehicle with hybrid or electric drive. The electrochemical energy store unit may be a battery or an accumulator battery and comprise for example lithium-ion cells. The cooling device may be a heat sink for the electrochemical energy store unit. The cooling ducts may be arranged adjacent to one another and connected at their respective ends to collecting tanks. The collecting tanks can receive a cooling fluid from, and deliver the cooling fluid back to, a cooling circuit. Each electrochemical energy store unit may have two opposite larger main surfaces and four smaller side surfaces. The side surfaces may form edge regions. The stack may be designed such that the main surfaces of adjacent electrochemical energy store units bear against or face towards one another. In different embodiments, the cooling ducts may make contact with the electrochemical energy store units in different regions thereof. The cooling ducts may be formed by cooling tubes.

In one embodiment of the energy store device, the multiplicity of cooling ducts may be formed as flat tubes. Flat tubes have the advantage that they can be fitted more effectively into the recesses between adjacent electrochemical energy store units.

In a further embodiment of the energy store units, each of the multiplicity of electrochemical energy store units may have a projection in at least one tapered edge region. Said projections may be designed such that recesses are formed in each case between the projections of the multiplicity of electrochemical energy store units. The electrochemical energy store units may for example each have a casing, and the projections may be formed by sealing formations of the casings. Such sealing formations are used for example in the case of “coffee bag” cells to close off the cell casing. In this case, the cooling ducts may be arranged between the sealing formations. The multiplicity of electrochemical energy store units may also each have at least one current conductor which may form the projection. In this case, the cooling ducts may be arranged between the current conductors.

Furthermore, insulators may be arranged between the projections and the cooling ducts. The insulators may be formed as a material piece or as a lacquer. The insulators can prevent an undesired flow of current between the conductor and the cooling device.

In one embodiment, cooling sheets may be arranged between adjacent electrochemical energy store units. Here, the cooling sheets may be thermally coupled to the cooling ducts. Here, the cooling sheets and cooling ducts may be in contact such that the cooling ducts can dissipate heat from the electrochemical energy store units via the cooling sheets. There may be a force-fitting or cohesive connection between the cooling sheet and energy store unit and between the cooling sheet and tube.

Furthermore, the cooling sheets may have, at a level of the tapered edge region, a bend in the direction of a projection of an adjacent electrochemical energy store unit. Adequate space is thus provided for the tubes to be fitted between the edge regions of the electrochemical energy store units.

In a further embodiment, the cooling sheets arranged between adjacent electrochemical energy store units may be folded and, at a level of the tapered edge region, have a bend in the direction of the projections of adjacent electrochemical energy store units. Here, a cross section of the cooling ducts may have a wedge shape which corresponds to a recess formed by the tapered edge region of two adjacent electrochemical energy store units.

Furthermore, each of the multiplicity of cooling ducts may have a cooling projection. The multiplicity of electrochemical energy store units may be arranged such that in each case at least one electrochemical energy store unit of the multiplicity of electrochemical energy store units is arranged between two adjacent cooling projections of the multiplicity of cooling ducts. It is thus possible for the cooling projections to be arranged between the electrochemical energy store units and for the cooling ducts to be situated outside the electrochemical energy store units. For this purpose, the cooling ducts may be arranged in or on a cooling plate.

In a further embodiment, in each case one central region of the at least one electrochemical energy store unit of the multiplicity of electrochemical energy store units may be arranged between two adjacent cooling ducts of the multiplicity of cooling ducts. In this way, a single cooling device may advantageously suffice for cooling the stack of electrochemical energy store units.

The present invention furthermore provides the use of a cooling device having a multiplicity of cooling ducts which are arranged spaced apart from one another and substantially parallel in a plane and which are formed such that a cooling fluid can flow through them, and at least one collecting tank which is arranged in the plane with and substantially perpendicular to the multiplicity of cooling ducts and is connected to said cooling ducts in order to receive the cooling fluid therefrom or deliver the cooling fluid thereto for the purpose of cooling a stack of a multiplicity of electrochemical energy store units. The approach according to the invention thus provides a novel use of a cooling device composed of modified mass-produced parts.

Advantageous exemplary embodiments of the present invention will be explained in more detail below with reference to the appended drawings, in which:

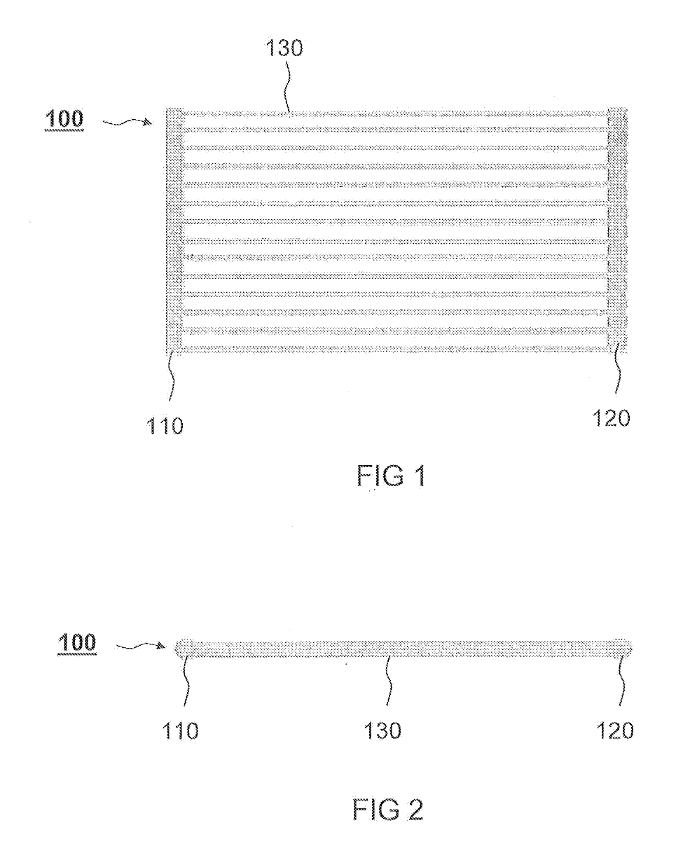

FIG. 1 shows a view of a cooling device as per one exemplary embodiment of the invention;

FIG. 2 shows a further view of the cooling device according to the invention;

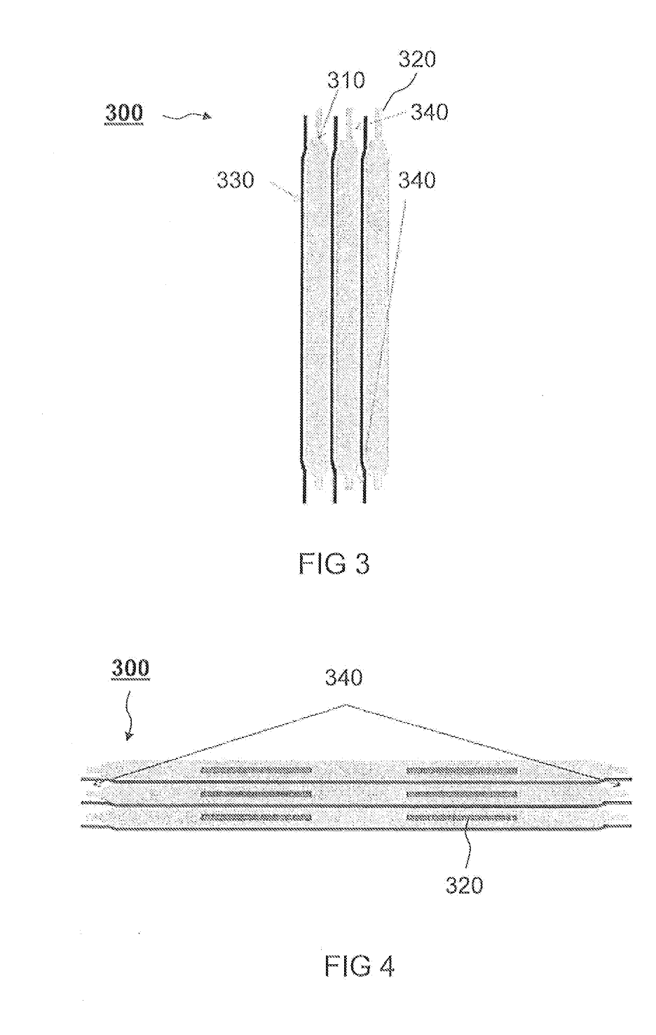

FIG. 3 shows a view of an energy store as per one exemplary embodiment of the invention;

FIG. 4 shows a view of an energy store according to the invention as per a further exemplary embodiment of the invention;

FIG. 5 shows a view of an energy store device as per one exemplary embodiment of the invention;

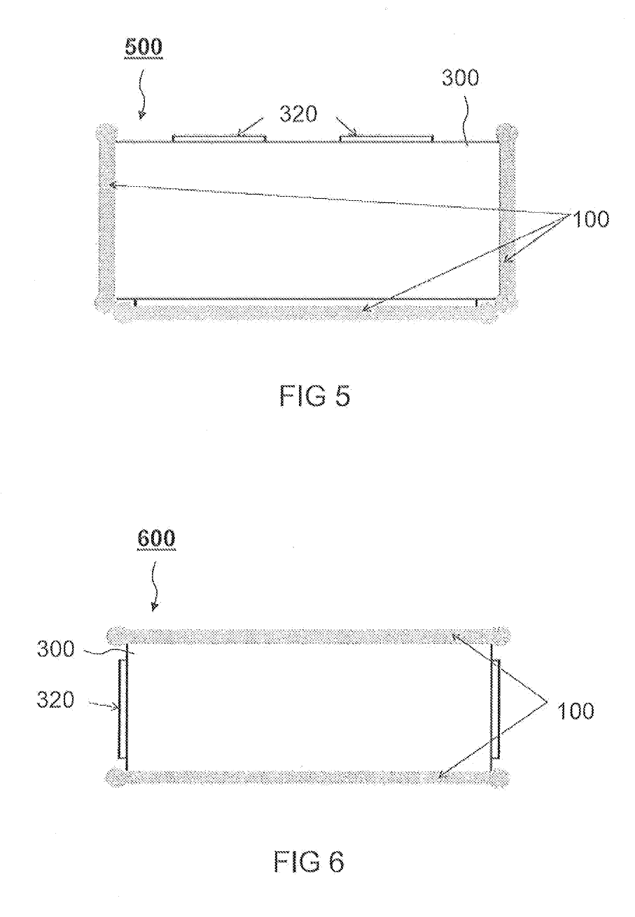

FIG. 6 shows a view of an energy store device as per a further exemplary embodiment of the invention;

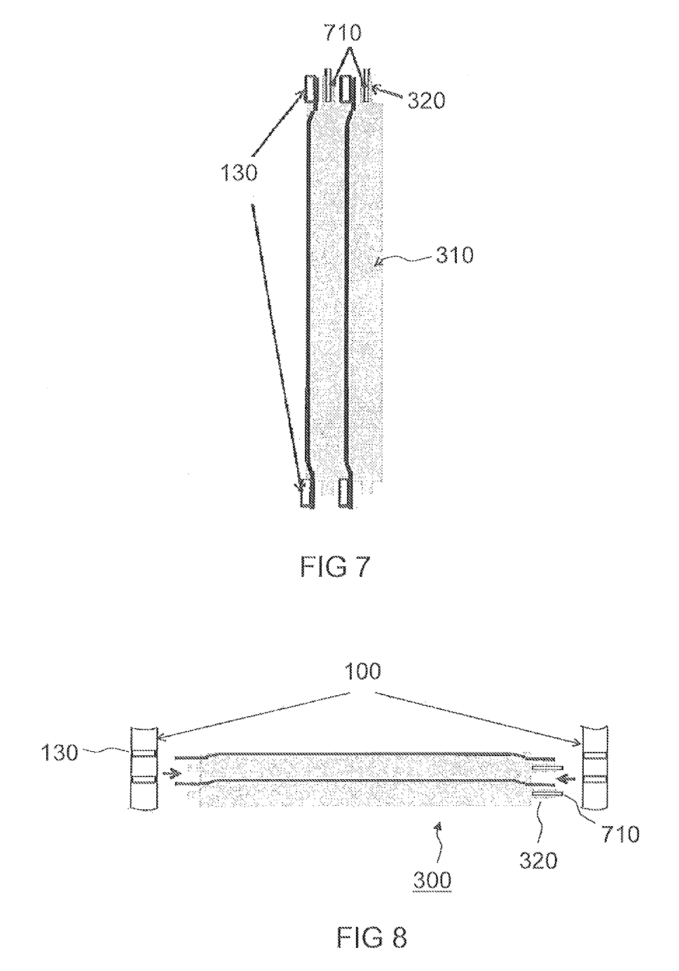

FIG. 7 shows a view of an energy store device as per a further exemplary embodiment of the invention;

FIG. 8 shows an illustration of the assembly of the energy store device according to the invention from FIG. 7;

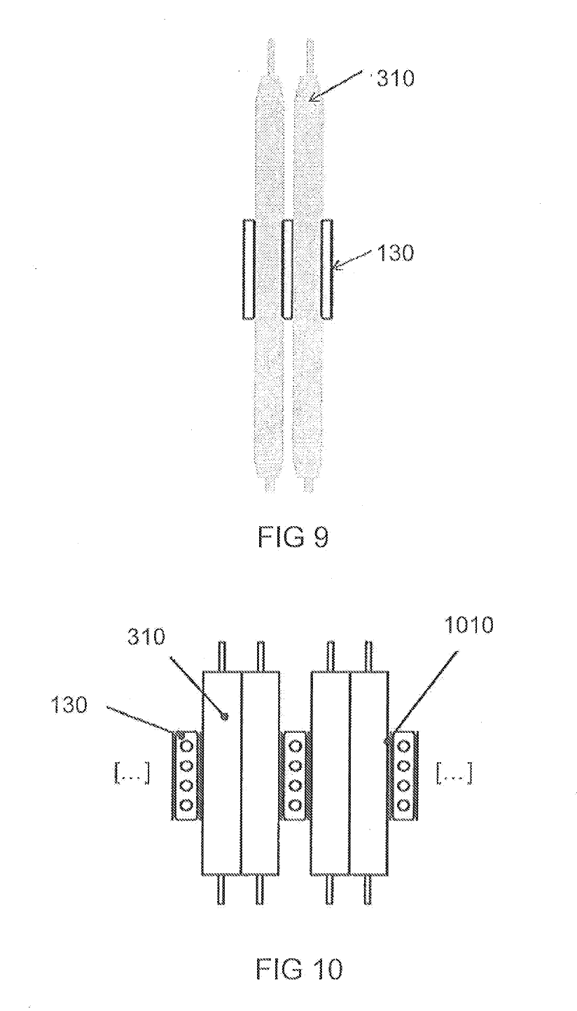

FIG. 9 shows a view of an energy store device as per a further exemplary embodiment of the invention;

FIG. 10 shows a view of an energy store device as per a further exemplary embodiment of the invention;

FIG. 11 shows a further view of the energy store device according to the invention from FIG. 10;

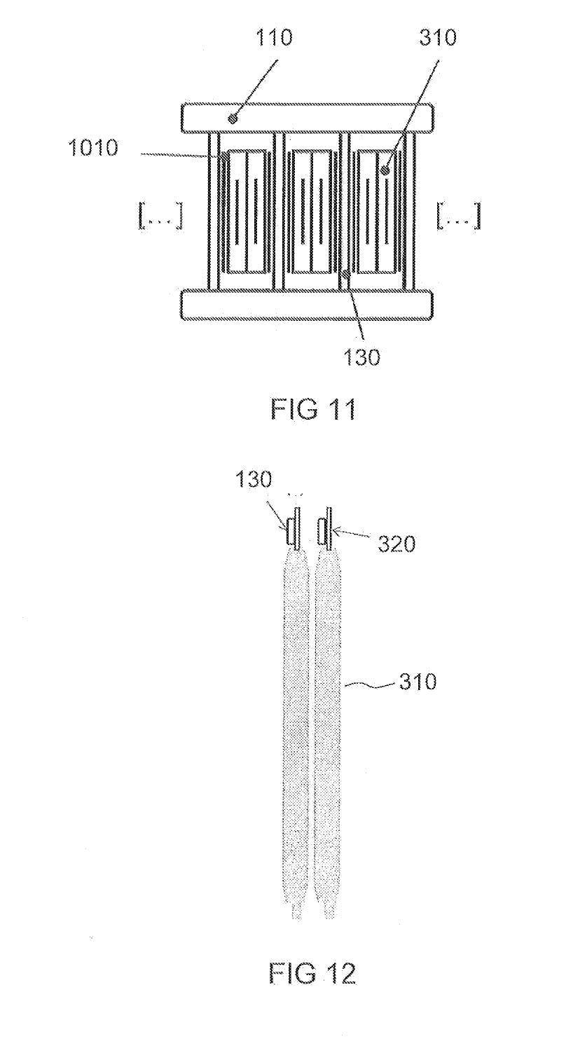

FIG. 12 shows a view of an energy store device according to the invention as per a further exemplary embodiment of the invention;

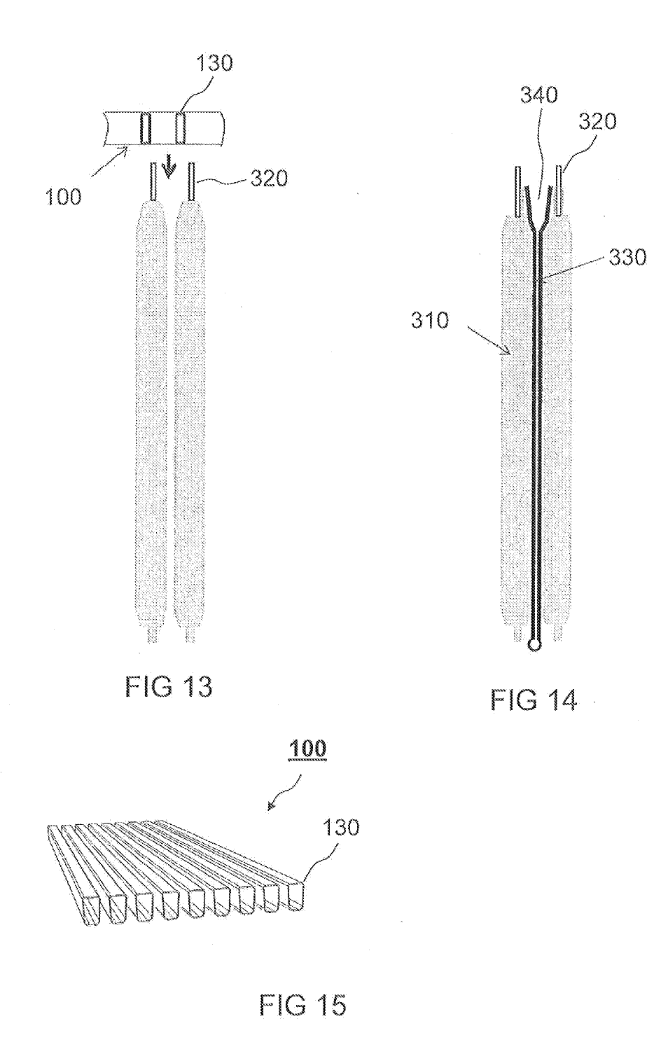

FIG. 13 shows a view of an energy store device according to the invention as per a further exemplary embodiment of the invention;

FIG. 14 shows a view of an energy store as per a further exemplary embodiment of the invention;

FIG. 15 shows a view of a cooling device as per a further exemplary embodiment of the invention;

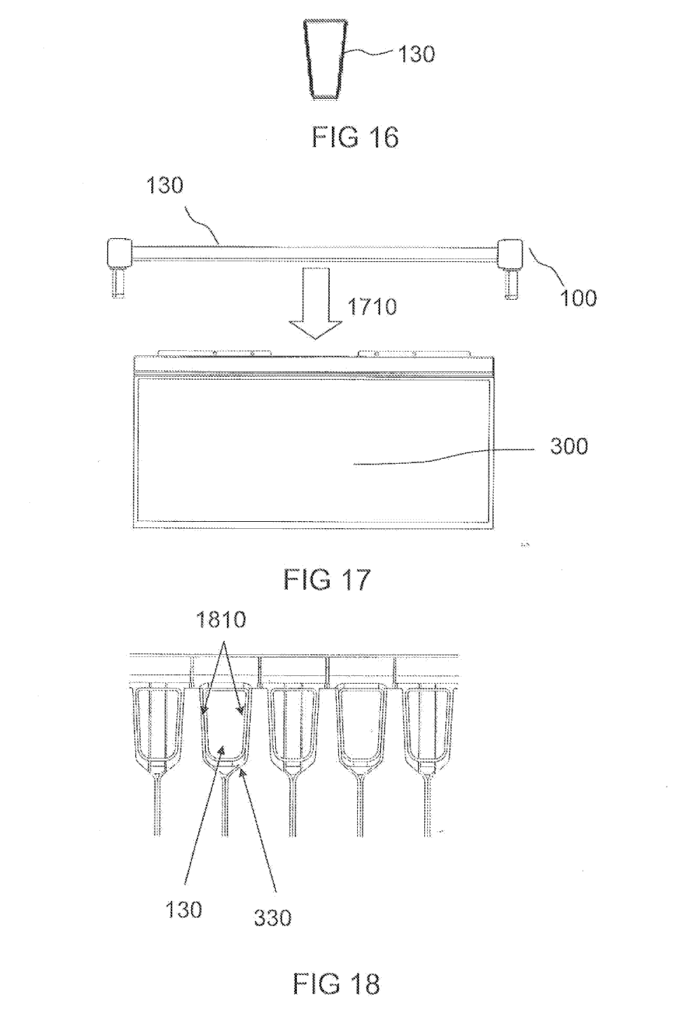

FIG. 16 shows a detail view of the cooling device according to the invention from FIG. 15;

FIG. 17 shows an illustration of the assembly of an energy store device as per a further exemplary embodiment of the invention;

FIG. 18 shows a view of an energy store device as per a further exemplary embodiment of the invention;

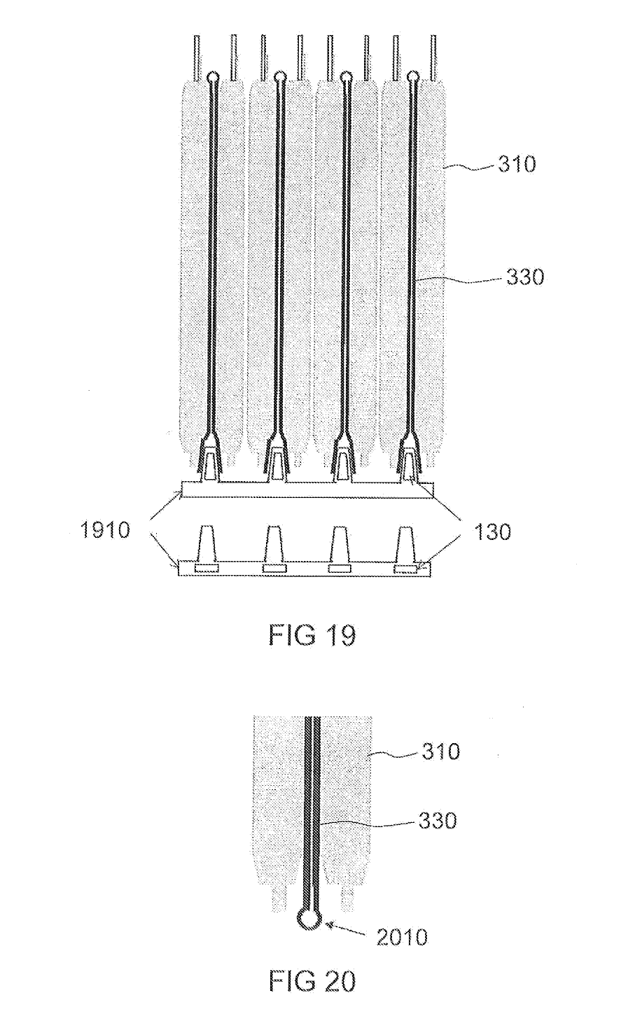

FIG. 19 shows a view of an energy store device as per a further exemplary embodiment of the invention; and

FIG. 20 shows a detail view of an energy store as per a further exemplary embodiment of the invention.

In the following description of the preferred exemplary embodiments of the present invention, the same or similar reference numerals will be used for elements of similar function illustrated in the various drawings, wherein a repeated description of said elements will not be given. Likewise, for clarity, if an identical element appears multiple times in a figure, in each case only one of the identical elements is provided with the relevant reference numeral.

FIG. 1 shows a view of a cooling device according to the invention as per one exemplary embodiment of the invention, which cooling device can be used for an energy store device according to the invention. The figure shows a flat-tube cooler or evaporator 100 without corrugated fins. The flat-tube cooler or evaporator 100 will also be referred to hereinafter as cooling device 100. The latter comprises a first collecting tank 110, a second collecting tank 120 and a multiplicity of cooling ducts 130 which are arranged between the first collecting tank 110 and the second collecting tank 120. As shown in FIG. 1, the cooling ducts 130 take the form of rectilinear tubes which are arranged parallel to and spaced apart from one another. At their respective ends, the tubes are connected to the collecting tanks 110, 120 such that a cooling fluid can flow through the cooling device 100 as a whole. The cooling ducts 130 may be formed for example as flat tubes.

FIG. 2 shows a further view of the cooling device 100 shown in FIG. 1. The figure shows the first water tank 110, the second water tank 120 and a cooling duct 130.

FIG. 3 shows a view of an energy store 300 according to the invention as per one exemplary embodiment of the invention. The energy store 300 comprises electrochemical energy store units or cells 310 with projections 320 and cooling sheets 330. The electrochemical energy store units 310 and the cooling sheets 330 are arranged in the form of a stack. Here, the cooling sheets 330 are in each case arranged between, and make contact with, two electrochemical energy store units 310. The cooling sheets 330 have bends along a contour of an edge region of the electrochemical energy store units 310. The projections 320 may for example be formed as sealing formations or conductors of the electrochemical energy store units 310 and arranged on end portions of the energy store units 310. Intermediate spaces or recesses 340 are formed between the end portions of the cooling sheets 330 and the projections 320.

The energy store 300 may also have more or fewer energy store units 310 and cooling sheets 330 than shown in FIG. 3 and the further figures.

FIG. 4 shows a further view of the energy store 300 as per a second exemplary embodiment of the invention. The energy store units 310 have further projections 320 which are formed as conductors.

FIGS. 5 and 6 show views of energy store devices 500, 600 according to the invention as per different exemplary embodiments of the invention.

In FIG. 5, the energy store device 500 comprises the energy store 300 and three cooling devices or coolers 100 in an arrangement around the cells of the energy store 300. In said exemplary embodiment, in each case one cooling device 100 is arranged on the sides and on the bottom of the energy store 300. A top side, which has the conductors 320, of the energy store 300 remains free. The cooling ducts of the cooling device 100 may be arranged within the recesses between the projections of the cells of the energy store 310. For this purpose, the dimensions of the cooling ducts and the spacings between adjacent cooling ducts may be adapted to the dimensions of the recesses of the energy store 300. Furthermore, the lengths of the cooling ducts and the lengths of the collecting tanks of the cooling devices 100 may be adapted to the external dimensions of the energy store 300.

By contrast, in the energy store device 600 shown in FIG. 6, in each case one cooling device 100 is arranged on the top and on the bottom of the energy store 300, while the sides, which have the conductors 320, of the energy store 300 remain free.

FIG. 7 shows a view of an energy store device according to the invention as per a further exemplary embodiment of the invention. The energy store device in turn has electrochemical energy store units 310, which are provided with projections 320, and cooling sheets 330. The energy store units 310 may be provided with a mechanical support. In the exemplary embodiment shown in FIG. 7, the projections 320 form conductors. Here, the cooling ducts 130 of the cooling device 100 are formed as flat tubes. As can be seen from FIG. 7, the cooling ducts 130 make contact with the cooling sheets 330 for dissipating heat from the electrochemical energy store units 310. To prevent a flow of current between the cooling ducts 130 and the conductors 320, the conductors 320 are provided with insulators 710. The insulation may be arranged on both sides of the conductor 320.

FIG. 8 shows an illustration of the assembly of the energy store device according to the invention from FIG. 7. In each case one cooling device in the form of a cooler 100 with cooling ducts 130 is arranged on opposite sides of the energy store 300. Said cooling device may be in each case the cooling device 100 shown in FIG. 1. In FIG. 8, the right-hand side of the energy store 300 has the insulators 710, such that in the assembled state of the energy store device 700, as can be seen in FIG. 7, a flow of current between the conductors 320 and the cooling ducts 130 can be prevented. No insulators are required on the left-hand side. Here, the projections may for example be sealing formations.

The connection of cells 310 via cooling sheets 330 to the heat sink 100 with flat tubes 130, as has been illustrated in conjunction with the exemplary embodiments from FIGS. 1 to 8, will be explained once again below.

Already mass-produced flat-tube coolers or evaporators 100 are produced without a corrugated fin profile and with possibly modified collecting tanks 110, 120 adapted in terms of width to the cells 310 and/or the cooling sheets 330 and in terms of overall length to the respectively desired number of cells 310. The use of said modified mass-produced parts reduces the development outlay and production costs and permits a highly variable modular construction.

The cells 310 are connected, for example by adhesive bonding, to the cooling sheets 330. The cooling sheets 330 are adapted to a surface of the cells 310 or to a geometry of a casing of the cells 310, as shown for example in FIG. 3. As a result of the adaptation of the cooling sheets 330 to the cell geometry, intermediate spaces or recesses 340 are formed between the lined-up cells 310, in particular at the level of the sealing formation 320 in the case of “coffee bag” cells.

The cooling sheets 330 may be connected to the flat tubes 130 for example by adhesive bonding. The flat tubes 130 run through the unused intermediate space 340 between the cells, in particular along the sealing edges 320 in the case of “coffee bag” cells. In this way, the available installation space can be optimally utilized and the packaging density can be increased.

As shown in FIGS. 5 and 6, one or more flat-tube coolers or evaporators 100 may be arranged around the cells 310 in accordance with the demanded cooling capacity. Here, the coolers 100 may be arranged so as not to be positioned in the vicinity of the conductor 320, for example so as to be positioned on the bottom and on the sides if the conductors 320 are mounted on the top, or on the top and on the bottom if the conductors 320 are mounted on the sides. By means of the corresponding insulation 710, an arrangement between the cells 310 in the region of the conductor 320, or of the sealing formation 320 of the cell 310 below the conductor 320, is also possible. The corresponding exemplary embodiment is shown in FIGS. 7 and 8.

“Coffee bag” cells 310 can be mechanically supported, together with the cooling sheets 330 connected thereto, already at a preparatory state by means of frames, form-fitting encapsulation or sealing compounds. Here, those points which, during later assembly, will be connected to the flat tubes 130 for heat transfer remain recessed. Such a construction may already have integrated therein connecting elements such as for example latching hooks, clips or the like, which enable the individual segments to be plugged together in a simple manner. Furthermore, the cells can also be insulated from one another in this way. One or more flat-tube coolers or evaporators 100 can subsequently be mounted, in the described way, on a stack of cells 310 thus constructed. As a result of the spacing between the flat tubes 130, the flat-tube cooler or evaporator 100 can be inserted or mounted into the stack or the cooling sheets 330 in a simple manner. This is illustrated in conjunction with the assembly illustration from FIG. 8. Adhesive layers applied already at a preparatory stage are thereby not damaged. Furthermore, the spacing between the flat tubes 130, makes it possible, for example, to realize the formation of an adhesive connection between flat tubes 130 and cooling sheets 330 with optimum parameters with regard to contact pressure. The use of tubes 130 instead of cooling plates reduces the weight of the cooling system as a whole.

Alternatively, cooling plates instead of flat tubes 130 may be mounted, with correspondingly modified cooling sheets 330.

A further possibility would be to connect the flat tubes 130 directly to the cell 310 if a thickness of the cell housing or of the cell casing exhibits good heat conduction corresponding to that of the cooling sheet 330. Corresponding exemplary embodiments following this approach are illustrated in FIGS. 9 to 13.

FIG. 9 shows an illustration of an energy store device as per a further exemplary embodiment of the present invention with an arrangement of flat tubes 130 and cells 310. Here, in each case one flat tube 130 is arranged between two cells 310 in a central region of the cells 310. Here, the flat tubes 130 may be arranged exactly centrally or offset with respect to the centre, and may have a small thickness but a large height. In this way, the contact surface between the flat tubes and the cells 310 is as large as possible, but the width of the stack of the cells 310 is increased only slightly. The flat tubes 130 may form cooling ducts of the cooling devices shown in FIGS. 1 and 2.

FIG. 10 shows a sectional illustration of an alternative exemplary embodiment to that shown in FIG. 9, in which in each case two adjacent battery cells 310 are arranged with the central region between two flat tubes 130. An adhesive bond or a sealing compound 1010 is provided between surfaces, which face in each case towards the cells 310, of the flat tubes 130 and casings of the cells 310 in order to connect the battery cells 310 to the flat tubes 130 of the cooler. The flat tubes 130 may each have a multiplicity of cooling ducts.

FIG. 11 shows a further view of the energy store device from FIG. 10. Said figure shows a paired arrangement of the cells 310 between the flat tubes 130 and the collecting tanks 110, 120 connected to the flat tubes 130.

The casing cooling of battery cells 310 via flat tubes 130 to collecting tanks 110, 120 described in conjunction with FIGS. 9 to 11, and the use of production methods from the field of coolant cooler production to produce battery coolers 100, will be described in detail below.

Again, it is possible for already mass-produced flat-tube coolers or evaporators without a corrugated fin profile and with possibly modified collecting tanks to be used and correspondingly adapted. It is also possible for existing production plants, such as for example through-type furnaces, to be used together with parts which are widely used nowadays, such as coolant coolers.

The cells 310 are connected directly, for example by adhesive bonding, to the flat tubes 130. The positioning is central, and not in contact with the whole of the casing surface of the cell 310. The heat dissipation from the surface which is not in contact takes place by heat conduction via the cell casing. Depending on the demanded cooling capacity, it is possible for one or more flat-tube coolers or evaporators to be arranged around the cells 310; it is alternatively also possible for the width of the tubes 130 to be adapted if the battery cell 310 itself cannot provide adequate internal heat conduction. The flat tubes 130 may be operated with coolant or refrigerant. The use of tubes 130 instead of cooling plates reduces the weight of the cooling system as a whole. For thermal contacting, it is possible, if necessary, for the cell assembly composed of cooler and cells 310 to be provided with a housing and to be sealed as a cohesive unit. The housing may remain on the cell assembly, for example as an insulation box, or may be removed after the hardening of the sealing compound.

Alternatively, thermal contacting of the cell assembly may also be realized by means of a clamping device. Here, there is merely contact, and no cohesive connection, between the flat tube 130 and cell 310. Here, the clamping device may be formed as a belt or as a clamping sheet. For electric insulation with respect to the battery cells 310 which may be at potential, the cooler may be provided with protective coatings such as for example lacquer.

It is alternatively possible for cooling plates with cooling sheets to be mounted. A further possibility would be to connect the flat tubes 130 to the cell 310 via cooling sheets.

FIG. 12 shows a view of an energy store device as per a further exemplary embodiment of the invention. The figure shows an arrangement of electrochemical energy store units 310 with conductors 320 and flat tubes 130. In the exemplary embodiment shown in FIG. 12, the flat tubes 130 make direct contact with the conductors 320. Here, in each case one flat tube 130 is arranged in a recess between two adjacent conductors 320 and is connected to one of the two conductors 320 and is spaced apart from the in each case other conductor 320. The flat tubes 130 may form cooling ducts of the cooling device shown in FIGS. 1 and 2.

FIG. 13 illustrates the assembly of the arrangement according to the invention from FIG. 12. It can be seen that the spacing between the flat tubes 130 of the cooler 100 is dimensioned such that, in the assembled state of the arrangement, in each case one flat tube 130 makes contact with one conductor 320.

In the exemplary embodiment, shown in conjunction with FIGS. 12 and 13, of conductor cooling of battery cells 310 via flat tubes 130 to collecting tanks, the conductor 320 of the cells 310 may be connected directly to the flat tubes 130, for example by adhesive bonding. This is advantageous in particular in the case of conductors 320 being positioned on one side of the cell 310. The dissipation of heat takes place directly from the cell 310 via the conductor 320 into the heat sink 130. To provide an adequate connecting surface, the conductors 320 may be lengthened. Good assembly of cell connectors in the electrical path is thus likewise possible. The flat tubes 130 may be operated with coolant or refrigerant. The use of tubes 130 instead of cooling plates reduces the weight of the cooling system as a whole. For electrical insulation with respect to the conductors 320 and to separate the thermal and electrical paths, the entire cooler 100 including the flat tubes 130 may be provided with protective coatings, for example lacquer.

It is alternatively possible for cooling plates with cooling sheets to be mounted. A further possibility would be to connect the flat tubes 130 to the cell 310 via cooling sheets, or to connect the flat tubes 130 directly to the cell casing.

FIG. 14 shows an arrangement of two cells 310, between which a folded cooling sheet 330 is arranged. The folded cooling sheet 330 has two limbs which bear in each case against a main side of the cells 310. In an end portion, the limbs each follow a contour of an edge region of the cells 310, such that the legs have in each case one bend towards the projections 320 of the cells 310. In the exemplary embodiment shown in FIG. 14, therefore, a funnel-shaped recess 340 is formed between the end portions of the limbs of the folded cooling sheet 330.

FIG. 15 shows a perspective illustration of an exemplary embodiment of a cooling device 100 suitable for the arrangement from FIG. 14. It is clear that the cooling device 100 has wedge-shaped flat tubes 130 running parallel.

FIG. 16 shows a cross section of one of the flat tubes 130 from FIG. 15. It can be seen that an outer contour of the flat tube 130 substantially corresponds to a shape of the funnel-shaped recess, shown in FIG. 14, of the end region of the cooling sheet.

FIG. 17 shows an illustration of the assembly of the flat tubes of a flat tube cooler 100 on cooling sheets of a cell stack 300. An arrow 1710 indicates the direction in which the cooler 100 is connected, for example by adhesive bonding, to the cell stack 300.

FIG. 18 shows a sectional illustration of an arrangement of flat tubes 130 and cooling sheets 330 as may be formed by the assembly illustrated in conjunction with FIG. 17. The wedge-shaped flat tubes 130 bear with their outer surfaces against the inner surfaces of the funnel-shaped recesses formed by the folded cooling sheets 330. An adhesive 1810 provides a connection of the cooling sheets 330 to the flat tubes 130.

FIG. 19 shows an illustration of an energy store device as per an alternative exemplary embodiment according to the invention. The figure shows in each case pairs of cells 310 between which is arranged in each case one folded cooling sheet 330. It is possible for no cooling sheet to be arranged between adjacent pairs of cells 310. The folded cooling sheets may be formed as described on the basis of FIG. 14. In said exemplary embodiments, the cooling ducts 130 may be connected to a plate 1910. FIG. 19 thus shows the arrangement and positioning of folded cooling sheets 330 and of a plate 1910 with ducts 130. In the exemplary embodiment shown here, the cooling plate 1910 may for example be an extruded part which has cooling projections and which has the tubes or cooling ducts 130.

FIG. 19 shows two possible designs of the cooling plate 1910. In one embodiment, the ducts 130 are arranged in the projections of the cooling plate 1910. In the illustration in FIG. 19, the cooling plate 1910 is, in said embodiment, arranged on the cooling sheets. Alternatively, the ducts 130 may also be arranged directly in the cooling plate 1910, adjacent to the projections, as shown at the bottom of the illustration.

FIG. 20 shows a detail view of a fold region of the folded cooling sheet 330 between two cells 310. Formed between the limbs is an opening 2010 for receiving for example pins for retaining the energy store device.

For the cooling of battery cells 310 via flat tubes 130 to collecting tanks, it is possible, as per the exemplary embodiments from FIGS. 14 to 20, for one or more cells 310 to be connected to a doubled-over cooling sheet 330 for example by adhesive bonding. The doubled-over, symmetrical cooling sheet 330 is composed of a centrally folded sheet, the open ends of which form a V-shaped or wedge-shaped opening 340. Said shape facilitates the assembly of the flat-tube cooler 100, for example by adhesive bonding with or without thermally conductive adhesive. The use of wedge-shaped flat tubes 130 additionally improves assembly and permits a good adhesive bond between the flat tube 130 and the V-shaped or wedge-shaped cooling sheets 330. The tubes 130 may for this purpose be formed as extruded profiles. As a result of the wedge-shaped connection, the contact area is enlarged in relation to a parallel connection.

The flat tubes 130 may also be formed as a single extruded part and, for example in the form of a plate 1910 with tubes 130 mounted thereon, may also be mounted on the opposite side of the conductor. In this way, the cooling system can simultaneously perform a structural function. The flow ducts may be situated either in the tubes 130 or in the plate 1910. A plurality of cells with cooling sheets may be combined to form a module with one extruded part.

The cooling sheets 330 may be of rounded form in the bend region. In the case of the folded cooling sheet 330, said region is thus tubular and can serve as a receptacle 2010 for pins or the like. Said inserted pins may for example be latched into a receptacle of the housing or of some other structural part. This permits simple assembly of the module in an overall construction.

The described exemplary embodiments have been selected merely by way of example and may be combined with one another.

1. An energy store device having the following features:
a multiplicity of cooling ducts which are arranged spaced apart from one another and substantially parallel in a plane and which are formed such that a cooling fluid can flow through them;
at least one collecting tank which is arranged in the plane with and substantially perpendicular to the multiplicity of cooling ducts and is connected to said cooling ducts in order to receive the cooling fluid therefrom or deliver the cooling fluid thereto; and
a stack of a multiplicity of electrochemical energy store units which are arranged such that in each case at least one energy store unit of the multiplicity of electrochemical energy store units is arranged between two adjacent cooling ducts of the multiplicity of cooling ducts.

2. The energy store device as claimed in claim 1, in which the multiplicity of cooling ducts are formed as flat tubes.

3. The energy store device as claimed in claim 1, in which each of the multiplicity of electrochemical energy store units has, in at least one tapered edge region, a projection such that recesses are formed in each case between the projections of the multiplicity of electrochemical energy store units, and wherein the cooling ducts are arranged in the recesses.

4. The energy store device as claimed in claim 1, in which the electrochemical energy store units each have a casing and the projections are formed by sealing formations of the casings.

5. The energy store device as claimed in claim 1, in which the multiplicity of electrochemical energy store units each have at least one current conductor which forms the projection.

6. The energy store device as claimed in claim 1, in which insulators are arranged between the projections and the cooling ducts.

7. The energy store device as claimed in claim 1, in which cooling sheets are arranged between adjacent electrochemical energy store units, wherein the cooling sheets are thermally coupled to the cooling ducts.

8. The energy store device as claimed in claim 1, in which the cooling sheets have, at a level of the tapered edge region, a bend in the direction of the projection of an adjacent electrochemical energy store unit.

9. The energy store device as claimed in claim 1, in which the cooling sheets arranged between adjacent electrochemical energy store units are folded and, at a level of the tapered edge region, have a bend in the direction of the projections of adjacent electrochemical energy store units.

10. The energy store device as claimed in claim 1, in which each of the multiplicity of cooling ducts has a cooling projection, and the multiplicity of electrochemical energy store units are arranged such that in each case at least one electrochemical energy store unit of the multiplicity of electrochemical energy store units is arranged between two adjacent cooling projections of the multiplicity of cooling ducts.

11. The energy store device as claimed in claim 1, in which the multiplicity of cooling ducts is arranged in or on a cooling plate.

12. The energy store device as claimed in claim 1, in which in each case one central region of the at least one electrochemical energy store unit of the multiplicity of electrochemical energy store units is arranged between two adjacent cooling ducts of the multiplicity of cooling ducts.

13. The use of a cooling device having a multiplicity of cooling ducts which are arranged spaced apart from one another and substantially parallel in a plane and which are formed such that a cooling fluid can flow through them, and at least one collecting tank which is arranged in the plane with and substantially perpendicular to the multiplicity of cooling ducts and is connected to said cooling ducts in order to receive the cooling fluid therefrom or deliver the cooling fluid thereto for the purpose of cooling a stack of a multiplicity of electrochemical energy store units.
